(19) United States
(12) Patent Application Publication
(10) Pub. No.: US 2007/0177113 A1
(43) Pub. Date: Aug. 2, 2007

(54) DIGITAL IMAGE PROJECTION METHODS AND APPARATUS THEREOF

(75) Inventor: Andrew Gerrit Huibers, Sunnyvale, CA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/620,537

(22) Filed: Jan. 5, 2007

Related U.S. Application Data
(60) Provisional application No. 60/756,942, filed on Jan. 5, 2006.

(51) Int. Cl. G03B 3/00

(52) U.S. Cl. 353/101

(57) ABSTRACT

Disclosed herein is a method of projecting images using light valves. Pixel patterns generated of the light valve pixels based on image data are projected at different locations at a time.

### CROSS-REFERENCE TO RELATED CASES

This U.S. patent application claims priority under 35 U.S.C. 119(e) from co-pending U.S. provisional application Ser. No. 60/756,942 to Andrew Huibers, filed Jan. 5, 2006, the subject matter of which is incorporated herein by reference in its entirety.

Subject matter of co-pending U.S. patent application Ser. No. 11/300,184 filed Dec. 14, 2005 and Ser. No. 11/169,990 filed Jun. 28, 2005 and U.S. provisional patent application Ser. No. 60/678,617 filed May 5, 2005 are incorporated herein by reference in entirety.

Subject matter of the following publications are incorporated herein by reference in entirety:

| | |
|---|---|
| US pat. 5402184 | US pat. 2003-0020809 |
| US pat. 2003-063226 | US pat. 2004-032419 |
| US pat. 6317169 | US pat. 6313888 |
| US pub. 2002-0135729 | US pub. 2003-0098945 |
| US pub. 2003-0222980 | US pat. 6384816 |
| US pub. 2004-027313A1 | US pub.2004-027363A1 |
| US pub. 2004-028293A1 | US pub.2005-024391A1 |
| US pub. 2005-025388A1 | US pub.2005-068335A1 |
| US pub. 2005-069209A1 | US pub.2005-093894A1 |
| US pub. 2005-093895A1 | US pub.2005-099534A1 |
| US pat. 6439726 | US pat. 6784946 |
| US pat. 5490009 | US pat. 6384816 |
| EP 01001306A2 | EP 00712243A2 |
| EP 00712243A3 | EP 00712243B1 |
| EP 00790514A2 | EP 00790514A3 |

### TECHNICAL FIELD

The technical field of the examples to be disclosed in the following sections relates to the art of image projection, and more particularly, to method of projecting images with light valves composed of reflective or transmissive pixels that are individually addressable.

### BACKGROUND

In projection systems that utilize reflective light valves (such as micromirror-based spatial light modulators) and transmissive light valves (such as LCD-based spatial light modulators), images are produced by modulating incident light beams with individually addressable pixels of the light valves. The number of addressable pixels in a light valve predominately determines the resolution of the projected images. Specifically, the more addressable pixels a light valve has, the higher resolution the projected images can be. However, the number of addressable pixels in a single light valve is subject to many limitations in both manufacturing and factors from other components of the light valve. Increasing the image resolution by enlarging the number of addressable pixels increases the cost and complexity of the pixels in the light valve.

Therefore, what is needed is a method of projecting images of higher perceived resolutions from a light reflective valve with less addressable pixels.

### SUMMARY

In one example, a method for shifting a pixel image on a target is disclosed, which comprises the steps of: directing light from a light source onto a spatial light modulator; modulating individual spatial light modulator elements; forming pixel images from light from the spatial light modulator elements on a target; vibrating a projection lens so as to shift the pixel images from the spatial light modulator elements on the target. The projection lens can be vibrated with a piezoelectric actuator. The piezoelectric actuator can be attached directly or indirectly to a housing encasing the projection lenses. The housing may comprise a hinge to which the projection lens is attached and held within the housing enclosure. The projection lens can be rotationally vibrated or translationally vibrated or a combination thereof. The piezoelectric actuator provides 250 N of force or more. The spatial light modulator is a micromirror array, a transmissive liquid crystal display, or a liquid crystal on silicon (LCOS) chip.

The projection lens can be vibrated rotationally via rotational movement of a housing of an assembly of projection optics, or can be vibrated translationally via translational movement of a housing of an assembly of projection optics. The vibration of the projection lens can be a sine wave when plotted as distance moved over time, or any other suitable forms.

The vibration of the projection lens can be through a total distance of 10 microns or less, 5 microns or less, and more preferably through a total distance of from 1 to 50 microns, such as through a total distance of from 1 to 25 microns, and from 1 to 15 microns.

With the movable projection lens, the pixel images can be shifted from first positions to second positions due to the vibration of the projection lens. A frame of image data is provided to form a first sub frame of image data and a second sub frame of image data, wherein the first sub frame of image data is provided to the spatial light modulator when pixel images are in the first positions on the target and wherein the second sub frame of image data is provided to the spatial light modulator when the pixel images are in the second positions on the target. Alternatively, the pixel images can be continued to be shifted from second positions to third positions due to the vibration of the projection lens, or from third positions to fourth positions due to the vibration of the projection lens. The pixel images can further be shifted to more than four positions due to the vibration of the projection lens.

The pixel positions can be substantially linear on the target. The spatial light modulator can be comprised of a rectangular array of spatial light modulator elements, and wherein a direction of vibration of the projection lens can be at a substantially 45 degree angle to a side of the rectangular array. The individual spatial light modulator elements can be substantially square and have sides that are substantially parallel to sides of the rectangular array. Alternatively, the spatial light modulator can be comprised of a rectangular array of spatial light modulator elements, and wherein a direction of vibration of the projection lens is at a substantially 90 degree angle to a side of the rectangular array. The examples as discussed above and their equivalences can be applied to rear projection systems and front projection system.

In another example, a projection system is disclosed herein. The system comprises: a light source for providing light to a spatial light modulator; a spatial light modulator with a plurality of spatial light modulator elements for spatially modulating light from the light source; a projection lens through which light from the spatial light modulator passes; and means for vibrating the projection lens.

In yet another example, a projection system is disclosed. The system comprises: a light source for providing light to a spatial light modulator; a spatial light modulator with a plurality of spatial light modulator elements for spatially modulating light from the light source; a projection lens through which light from the spatial light modulator passes; and a piezoelectric actuator provided for moving the projection lens.

In yet another example, a method for shifting a pixel image on a target is disclosed. The method comprises: directing light from a light source onto a spatial light modulator; modulating individual spatial light modulator elements; forming pixel images from light from the spatial light modulator elements on a target; vibrating a visible light transmissive plate through which light passes from the spatial light modulator to the target, so as to shift the pixel images from the spatial light modulator elements on the target.

In still yet another example, a method for shifting a pixel image on a target is disclosed herein. The method comprises: directing light from a light source onto a spatial light modulator; modulating individual spatial light modulator elements; forming pixel images from light from the spatial light modulator elements on a target; vibrating the spatial light modulator so as to shift the pixel images from the spatial light modulator elements on the target.

In yet another example, a method for shifting a pixel image on a target is disclosed. The method comprises: directing light from a light source onto a spatial light modulator; modulating individual spatial light modulator elements; forming pixel images from light from the spatial light modulator elements on a target; vibrating a visible light transmissive member within an optical path of a light beam from the light source in a rotational manner so as to shift the pixel images from the spatial light modulator elements on the target.

In yet another example, a projection system is disclosed herein. The method comprises: a light source for providing light onto a spatial light modulator; a spatial light modulator having individual spatial light modulator elements which reflect or transmit light to a screen; means for vibrating the spatial light modulator so as to shift the pixel images from the spatial light modulator elements on the screen.

In yet another example, a projection system comprises: a light source for providing light onto a spatial light modulator; a spatial light modulator having individual spatial light modulator elements which reflect or transmit light to a screen; a piezoelectric mechanism connected directly or indirectly to the spatial light modulator so as to shift the pixel images from the spatial light modulator elements on the screen.

### BRIEF DESCRIPTION OF THE DRAWINGS

FIG. 1 demonstratively illustrates an exemplary image projection method with an exemplary pixel array;

FIG. 2 demonstratively illustrates an exemplary projection system employing the method illustrated in FIG. 1;

FIG. 3a and FIG. 3b demonstratively illustrates exemplary image pixels shifted on a screen;

FIG. 4 demonstratively illustrates exemplary image pixels shifted on a screen so as to achieve a perceived resolution higher than the number of pixels of the spatial light modulator used in projecting the image;

FIG. 5 demonstratively illustrates another exemplary image pixels shifted on a screen so as to achieve a perceived resolution higher than the number of pixels of the spatial light modulator used in projecting the image;

FIG. 6 demonstratively illustrates yet another exemplary image pixels shifted on a screen so as to achieve a perceived resolution higher than the number of pixels of the spatial light modulator used in projecting the image;

FIG. 7 an exemplary projection lens;

FIG. 8 demonstratively illustrates an exemplary projection lens of FIG. 7;

FIG. 9 is a perspective view of the projection lens in FIG. 8;

FIG. 10 is a side view of another exemplary projection lens;

FIG. 11 is a perspective view of the projection lens in FIG. 10;

FIG. 12 is a top view of the projection lens in FIG. 11 detailing the driving mechanisms thereof;

FIG. 13 is a top view of an exemplary projection system in which the projection lens is implemented;

FIG. 14 demonstratively illustrates an exemplary illustration system usable in the projection system of FIG. 13;

FIG. 15 demonstratively illustrates another exemplary projection system in which the projection lens is implemented;

FIG. 16 demonstratively illustrates another exemplary projection system in which the projection lens is implemented;

FIG. 17 illustrates an exemplary light source usable in the projection system of FIG. 16;

FIG. 18 is a cross-section view of an exemplary micromirror device usable in light valves employed in the projection system;

FIG. 19 is a perspective view of an exemplary micromirror of FIG. 18;

FIG. 20 is a cross-section view of an exemplary micromirror device usable in light valves employed in the projection system;

FIG. 21 is a cross-sectional view of the micromirror array device in a package;

FIG. 22 is a top view of an exemplary micromirror device usable in light valves employed in the projection system;

FIG. 23 is a top view of another exemplary micromirror device usable in light valves employed in the projection system;

FIG. 24 is a top view of another exemplary micromirror device usable in light valves employed in the projection system;

FIG. 25 is a block diagram showing the functional modules for operating the components of an exemplary projection system;

FIG. 26 demonstratively illustrates another exemplary projection system employing a mechanism capable of projecting modulated light from each pixel of a light valve onto different locations of the screen; and

FIG. 27 demonstratively illustrates yet another exemplary projection system employing a mechanism capable of projecting modulated light from each pixel of a light valve onto different locations of the screen.

### DETAILED DESCRIPTION OF EXAMPLES

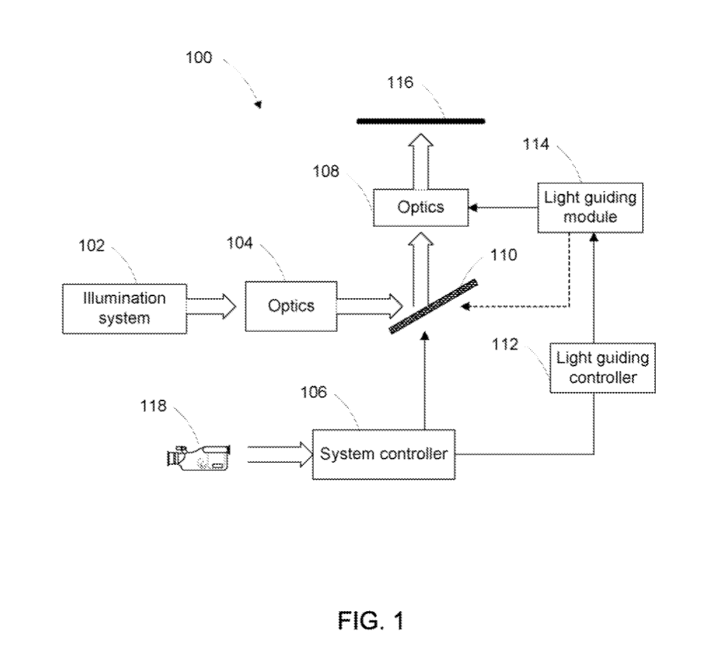

Turning to the drawings, FIG. 1 illustrates an exemplary projection system. In this example, projection system 100 comprises illumination system 102 for providing illumination light for the system. The illumination light is collected and focused onto reflective light valve 110 through optics 104. Light valve 110 that comprises an array of individually addressable pixels, such as micromirror devices, modulates the illumination light under the control of system controller 106. The modulated light is collected and projected to screen 116 by optics 108.

The projection optics (108) and/or the light valve (110) can be moved relative to the screen (116) such that the perceived resolution of the projected image can be higher than the number of pixels of the light valve used in projecting said image. Alternatively, the projected images associated with a frame of image data can be shifted on the screen so as to accomplish other requirements, such as obtaining images with smoothed edges but without unwanted artificial effects such as screen-door effect.

As one example, the position of the light valve relative to the screen can be fixed during the projection operation; while the position of the projection lens (108) relative to the screen (also the light valve) can be changed over time during the projection operation. As a result, a beam of light reflected from a pixel of the light valve can be directed to multiple positions (image pixels) on the screen over time during the projection operation.

As another example, the position of the projection optics (108) relative to the screen can be fixed during the projection operation; while the position of the light valve relative to the screen (also projection optics 108) can be changed over time during the projection operation.

In yet another example, both of the light valve and projection optics, such as the projection lens of the projection optics are moved over time during the projection operation. In this instance, movements of the light valve and projection lens can be independent (e.g. asynchronized) or can be dependent (e.g. synchronized).

In any instances, movements of the light valve and/or projection lens can be controlled by the light guiding module 114 that is further controlled by light guiding controller 112. The light guiding controller can be controlled by system controller 106.

As a way of example, the system controller receives a series of frames of media contents, such as images and videos, from media source 118. For achieving intermediate illumination intensities (e.g. the gray-scale) of the media contents, each frame of media contents is formatted into a set of bitplanes according a pulse-width-modulation technique. Each bitplane has one bit of data for each pixel of the image to be produced; and represents a bit-weight if intensity values to be displayed by the image pixel such that, each bitplane has a display time corresponding to its weight. During a frame period, the series of bitplanes derived from the same frame of media content (though not required) can be loaded to the pixels of the light valve; and used to control the ON and OFF states of the individual pixels of the light valve in modulating the incident light. The modulated light, however, is projected at different locations on the screen, which is accomplished through the light guiding module and light guiding controller. The light guiding module is capable of, statically or dynamically, projecting a single beam of modulated light at different locations on the screen under the control of the light guiding controller. Specifically, the entire series of bitplanes, or alternatively, a portion of the bitplanes, derived from each frame of media contents is displayed at different locations on the screen.

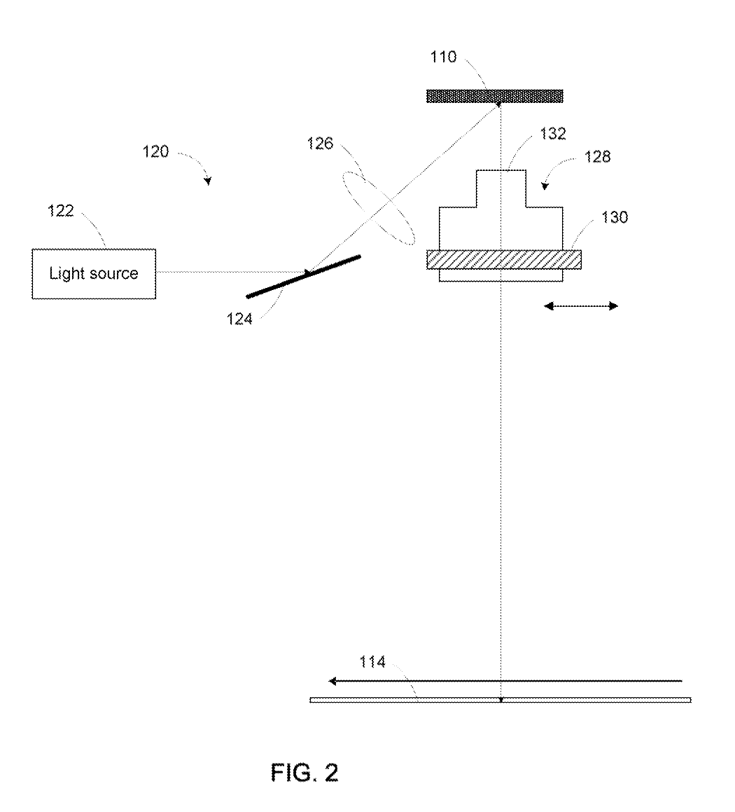

FIG. 2 demonstratively illustrates an exemplary projection system of the system as discussed above with reference to FIG. 1. Referring to FIG. 2, projection system 120 comprises light source system 122 providing illumination light. The light source system may comprise a light source (e.g. arc lamp, LED or any other desired light sources), a color wheel, and a light pipe. The light is reflected to illuminate light valve 110 through folding mirror 124 and condensing lens 126. The light valve modulates the incident light with image date derived from the image to be projected. The modulated light is collected and projected to screen 114 by projection lens assembly 128. In this example, the projection lens assembly comprises projection lens 132 and moving mechanism 130 provided to the projection lens such that the projection lens can be moved in position relative to the screen. Specifically, the projection lens can be moved in a direction parallel to the screen as shown in the figure during the projection operation. The movement of the projection lens can be in any desired forms, such as a sine waveform. The frequency of the movement of the projection lens is preferably 30 HZ or higher, more preferably 60 HZ or higher, 120 HZ or higher, 180 HZ or higher.

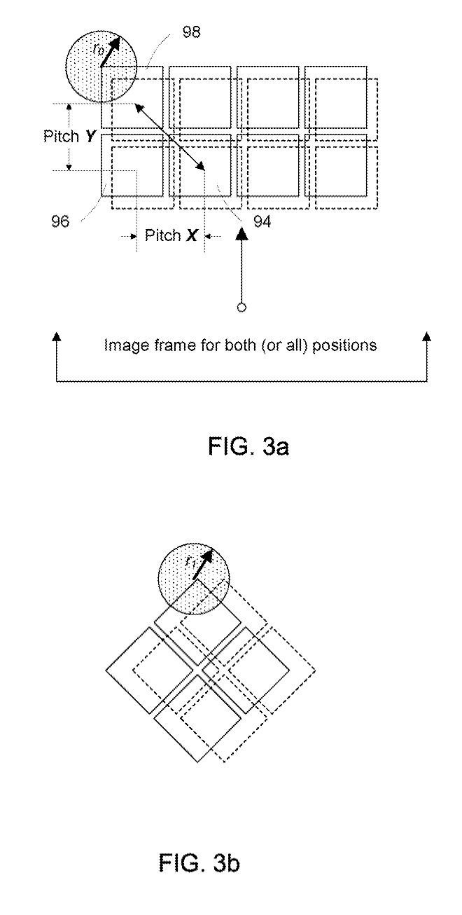

Due to the movements of the projection lens (and or the light valve) during the projection operation, a frame of image date can be projected on different locations on the screen. FIG. 3a demonstratively illustrates an example of such projection. Referring to FIG. 3a, media content frames, such as image frames and video frames are retrieved by the projection system, and each frame of the images (and/or videos), in entirety (e.g. without further derivation), is projected at different locations on the screen. Specifically, the desired media content can be (through not required) retrieved in frames by the projector. The frame rate can be around 45 HZ or more, 60 HZ or more, and 120 HZ or more. A frame of image date (e.g. bitplane data) commensurate with the projector is then derived from each image frame. The derived frame of image data is delivered to the pixels of the reflective light valve of the projector. Based on the image data, the pixels modulate the incident light. The modulated light is then projected at the different locations on the screen so as to reproduce the desired media content.

The different locations can be of any desired numbers, such as 2 or more, 3 or more, and 4 or more. The different locations at which the same image frame are projected on the screen can be arranged horizontally (e.g. parallel to the rows of the image pixels), vertically (e.g. parallel to the columns of the image pixel array), or along other desired directions, such as along the diagonal of image pixels.

As shown in FIG. 3a, solid squares represent the image pixels at the first location; while the dash-line squares represent the image pixels at the second location. For simplicity purposes, only four pixels on the screen at a time are illustrated. In general, the total number of image pixels can be any desired numbers, such as XGA, UXGA, and WXGA or any other numbers. The two locations can be offset along the diagonal of the image pixels with the offset distance within the shaded circle. The shaded circle may have a radius rₒ may equal to or less than half of the pitch along the offset direction or any other desired values, wherein the pitch is defined as the center-to-center distance between the adjacent image pixels along the offset direction. In this particular example as shown in FIG. 3a, the offset is along the diagonal of the image pixels, the pitch is the center-to-center distance between image pixels 98 and 94.

Instead of offsetting along the diagonal of the image pixels, the different locations can be offset along any other directions, such as horizontally (e.g. parallel to the rows of the pixel array) or vertically (e.g. along the columns of pixel array) or any combinations thereof. In the instance wherein the different locations are offset along the rows (or columns) of the image pixel array, the offset distance can be equal to and less than the half of the pitch size along the offset direction, or any other desired values.

Alternatively, the offset can be can be greater than gap (the shortest distance) between adjacent image pixels along the offset direction, but smaller than ⅓ of the pitch along the offset direction, more preferably, greater than 1.5 times of the gap but less than 3 times of the gap along the offset direction. For example wherein the offset is along the row, the offset can be greater than gap between adjacent image pixels 96 and 94, but smaller than ⅓ of pitch Pₓ, more preferably, greater than 1.5 times of the gap but less than 3 times of the gap along the offset direction.

In the example wherein the offset is along the column, the offset can be greater than gap between adjacent image pixels 98 and 96, but smaller than ⅓ of pitch P_{y}, more preferably, greater than 1.5 times of the gap but less than 3 times of the gap along the offset direction. Another example wherein the offset is along the rows of the image pixel array is schematically illustrated in FIG. 3b.

Referring to FIG. 3b, each image pixel of the image pixel array is rotated an angle, such as 45° degrees along the center of each individual image pixel, as compared to that show in FIG. 1. This configuration results in that each edge of every image pixel has an edge to any edges of the image pixel array, as set forth in U.S. Pat. No. 6,962,419 issued Nov. 8, 2005, the subject matter being incorporated herein by reference in entirety.

In an image projection, the same frame of images is projected at different locations on the screen. As shown in the figure, the solid squares represent the image pixels ate the first location; while the dash-line squares represent the image pixels at the second location. The fist and second locations have an offset along the rows of the image pixel array. The offset can be less than a/2 or any other desired values, wherein a is the length of the pixel of the light valve. Alternatively, the offset can be along the columns, which is not shown in the drawing, wherein the offset is preferably less than b/2 or any other desired values, wherein b is the width of the pixel of the light valve.

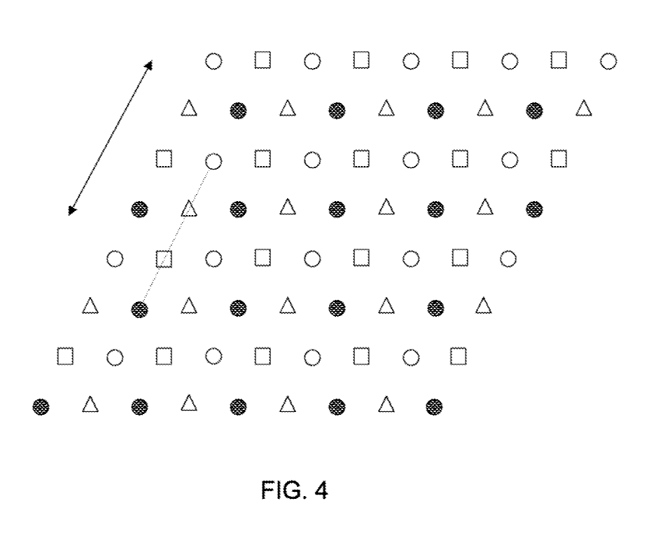

FIG. 4 schematically illustrates another exemplary image projection method. In this figure, different positions that are illuminated by the reflected light from the light valve over time are represented by different symbols. Specifically, the solid circles represent the first positions on which a frame of image data (or a portion of the image data frame) is projected during the first time interval. The open squares represent the second positions on which the image frame (or another portion of the image frame) is projected during the second time interval immediately after the first time interval. The open triangles represent the third positions on which the image frame (or another portion of the image frame) is projected during the third time interval immediately after the second time interval. The open circles represent the fourth positions on which the image frame (or another portion of the image frame) is projected during the fourth time interval immediately after the third time interval. The first to fourth time intervals in sum substantially equals a frame period. In the next frame period, such operations can be repeated. In the example as shown in FIG. 4, the different locations (the first to the fourth) are aligned along a straight line pointing towards a predetermined direction.

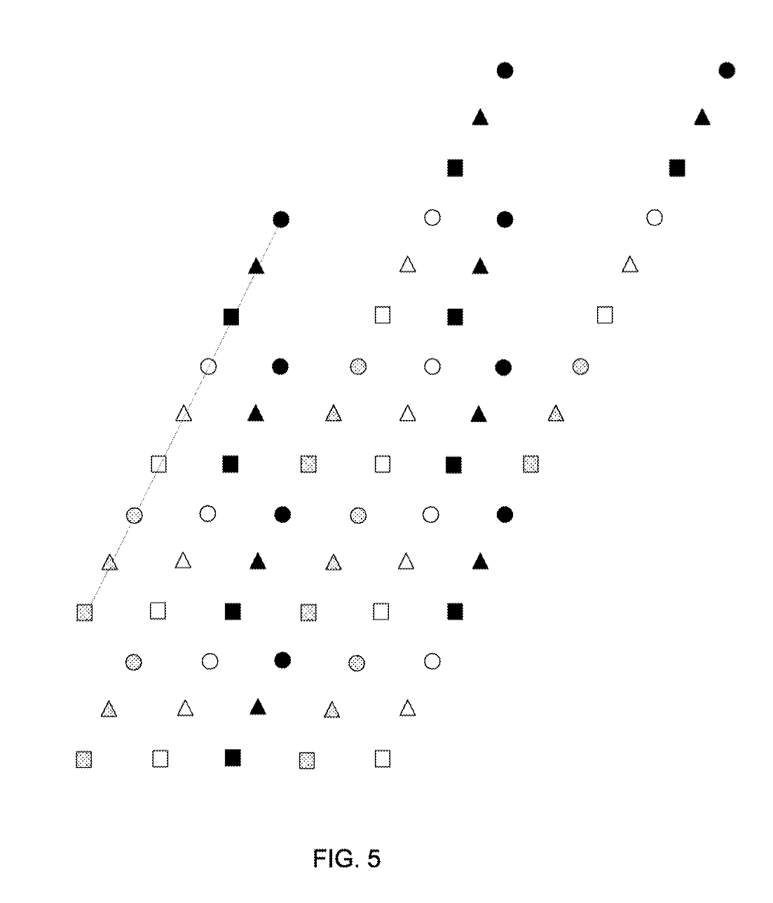

Other than four different locations on the screen, the image data frame (or portions of the image data frame) can be projected to more than four different locations, such as nine positions as shown in FIG. 5. Referring to FIG. 5, a frame of image data can be (or the portions of the image data that can be sequentially) projected on different locations on the screen. Such different locations are aligned along a straight line pointing towards a predetermined direction. These different locations are represented by different symbols in the order (over time) of: shaded square, shaded triangle, shaded circle, open square, open triangle, open circle, solid square, solid triangle, and solid circle. When portions of the entire frame data are sequentially projected onto these locations during each frame period, the perceived resolution of the image can be nine times of the number of pixels of the light valve used in projecting the image.

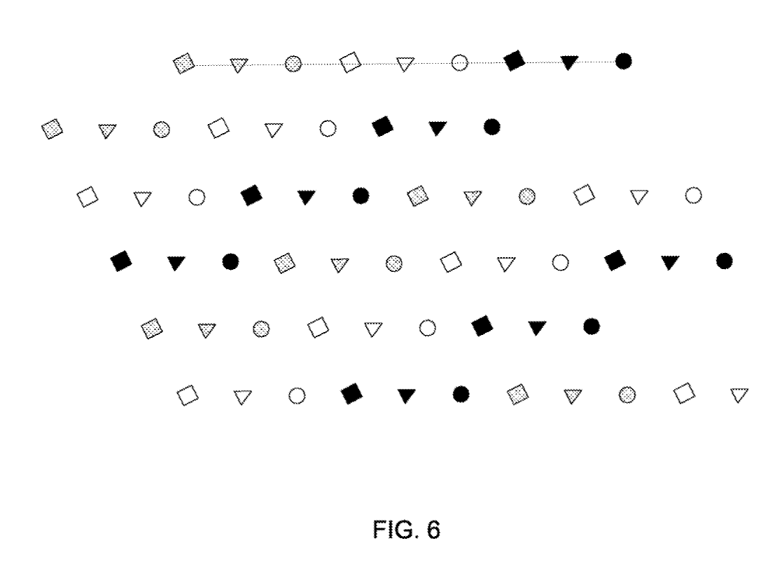

Of course, the image data can be projected onto any other desired number of different locations on the screen either in entirety, or in sequential portions, such as eight different locations on the screen. More preferably, 2 or more, 3 or more, 4 or more, 5 or more, 8 or more, and 9 or more different locations can be used. The line along which the different locations are aligned can be along any desired directions, such as vertically, or horizontally as shown in FIG. 6, or any desired directions.

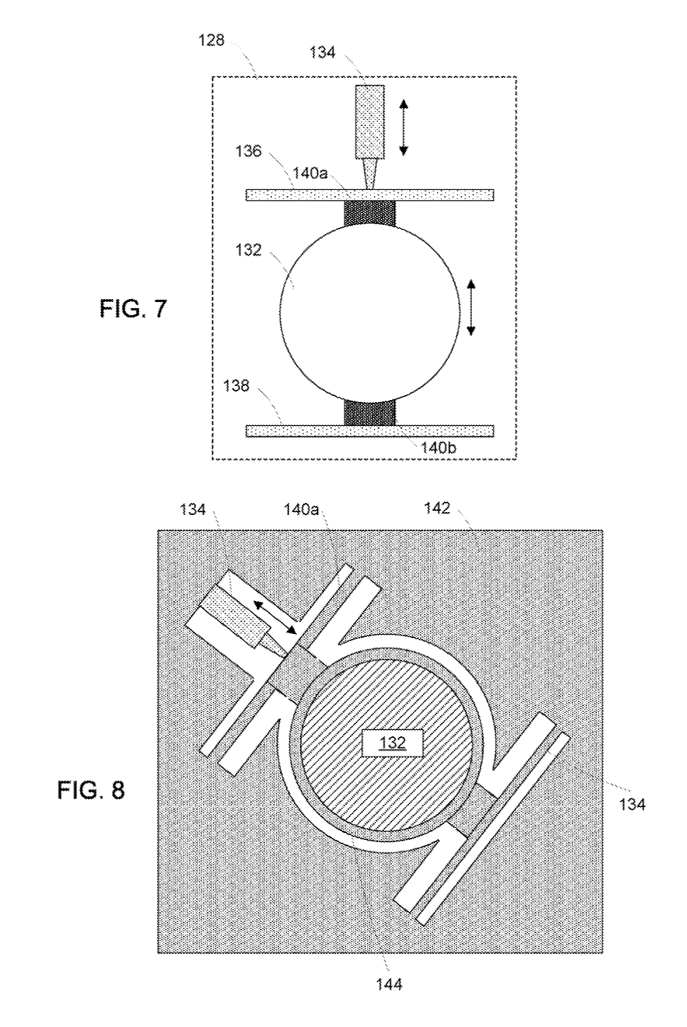

As discussed earlier, the projection lens of the projection assembly can be movable during the projection operation. Such movement can be accomplished by equipping the projection lens assembly with a driving mechanism, as shown in FIG. 7.

Referring to FIG. 7, projection lens assembly 128 comprises projection lens 132 that can be attached to hinges 136 and 138 via hinge contacts 140a and 140b, respectively. The hinge contacts can be preferably rigid bodies, or plastic materials, or elastomers, but more rigid than the hinges. The hinges can be flexure hinges or torsion hinges. Driving mechanism 134, such as a mechanical device provided with a piezo-electrical device is attached to one of the hinges such that said hinge can be deformed. As the hinge(s) deforms, projection lens 132 can be moved.

The vibration of the projection lens can be through a total distance of any suitable values, such as 10 microns or less, 5 microns or less, and more preferably through a total distance of from 1 to 50 microns, such as through a total distance of from 1 to 25 microns, and from 1 to 15 microns.

With the movable projection lens, the pixel images can be shifted from first positions to second positions due to the vibration of the projection lens. A frame of image data is provided to form a first sub frame of image data and a second sub frame of image data, wherein the first sub frame of image data is provided to the light valve when pixel images are in the first positions on the target and wherein the second sub frame of image data is provided to the spatial light modulator when the pixel images are in the second positions on the target. Alternatively, the pixel images can be continued to be shifted from second positions to third positions due to the vibration of the projection lens, or from third positions to fourth positions due to the vibration of the projection lens. The pixel images can further be shifted to more than four positions due to the vibration of the projection lens.

As one example, FIG. 8 demonstratively illustrates in the top view of a projection lens assembly. In this example, plate 142, such as a metallic, plastic, or elastomer plate is provided. The plate is patterned so as to form hinges 140a and 140b by trenches. Holding frame 144 can also be derived from the plate on which projection lens 132 can be mounted. The holding frame can be a circular plate substantially in the same shape of projection lens, or any other desired shapes. Driving mechanism 134 is placed within a cavity derived from the plate such that one end of the driving mechanism is abut against a fixed surface of the cavity with the other end connected to one of the two hinges for deforming said hinge.

When installing such projection lens assembly in a projection system, the moving direction of the driving mechanism (also the moving direction of the projection lens) is desired to be aligned to the light valve of the projection system so as to accomplish the projection on the desired different locations. As one example, the pixel positions can be substantially linear on the target. The light valve can be comprised of a rectangular array of light valve, and wherein a direction of vibration of the projection lens can be at a substantially 45 degree angle to a side of the rectangular array. The individual light valve pixels can be substantially square and have sides that are substantially parallel to sides of the rectangular array. Alternatively, the light valve can be comprised of a rectangular array of light valve pixels, and wherein a direction of vibration of the projection lens is at a substantially 90 degree angle to a side of the rectangular array. The examples as discussed herein and equivalences within the scope can be applied to rear projection systems and front projection system.

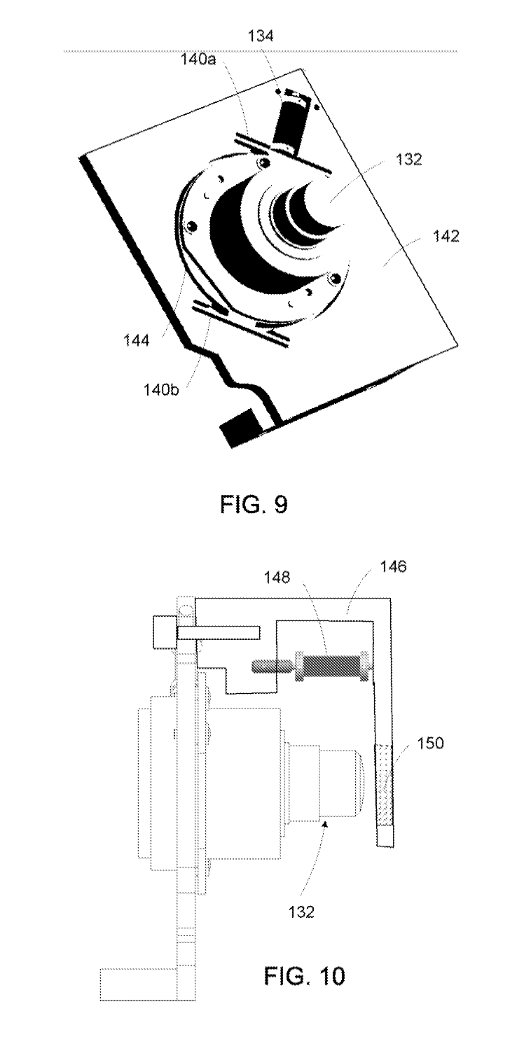

A perspective view of the projection lens assembly in FIG. 8 is illustrated in FIG. 9. As can be seen in the figure, projection lens 132 is mounted on holding frame 144. The holding frame is connected to hinges 140a and 140b such that the holding frame and the projection lens mounted thereon can be moved as the hinges deform. Driving mechanism 134 is placed at a location in a cavity of the plate for deforming the hinges.

As an alternative feature, the projection lens can be provided with movable light transmissive window 150, as shown in FIG. 10. Referring to FIG. 10, transparent window 150 is displaced on the propagation path of the light exiting the projection lens and mounted on window holder 146 through a deformable window arm. Another driving mechanism 148 is place such that one end of the driving mechanism abuts against a fixed portion of the assembly; while the other end abuts against the deformable window arm for deforming the window arm. As the window arm deforms, the transparent window is capable of rotating relative to projection lens 132. Because the transparent window is capable of moving, the light beam from exiting the projection lens can also be projected at different locations on the screen.

In the above example, the transparent window is placed between the projection lens and the screen on which the desired images are projected. Alternatively, the transparent window can be placed on the opposite side of the projection lens relative to the screen, which is not illustrated in the figure. Meanwhile, the figure shows that the projection lens assembly comprises transparent windows and projection lens that both are movable. In another example, only one of the projection lens and transparent window can be made movable, in which instance, only one driving mechanism may be necessary.

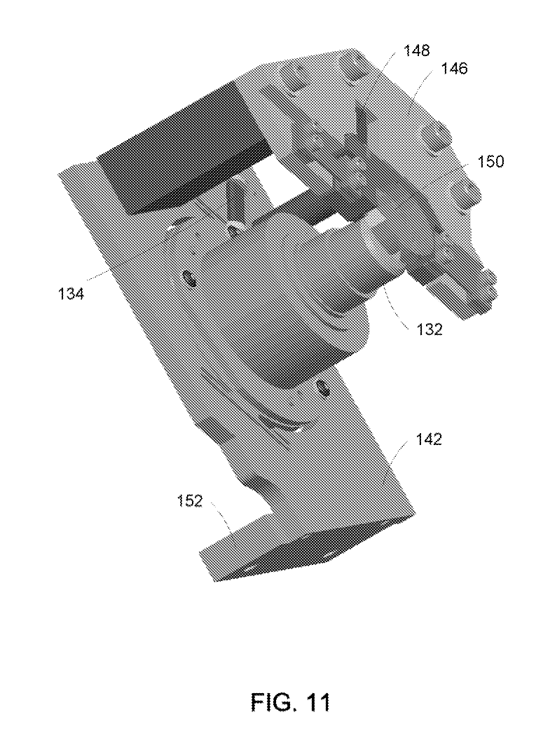

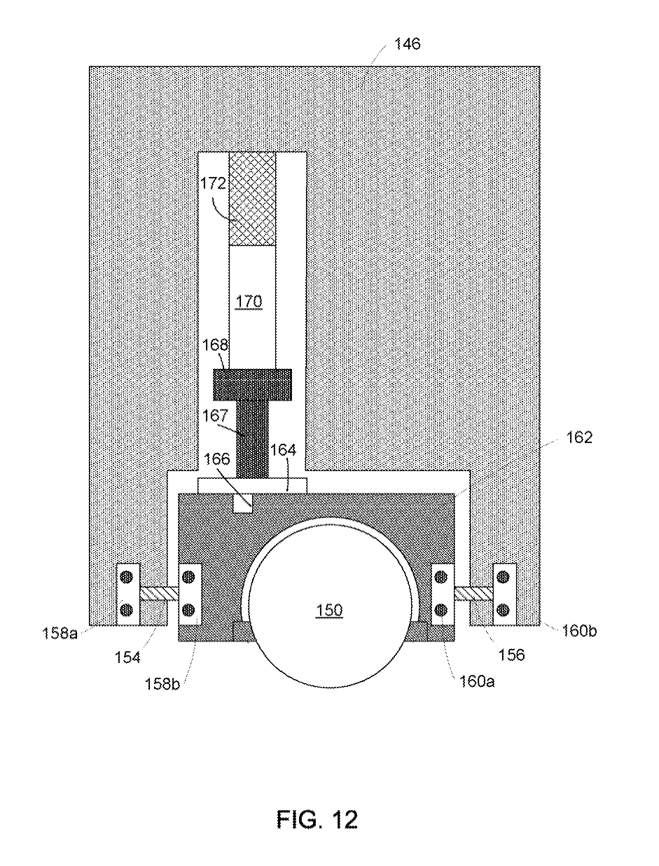

FIG. 11 shows a perspective view of the projection lens assembly of FIG. 10, a top view of which is illustrated in FIG. 12. Referring to FIG. 12, transparent window 150 is mounted on window holder 162. The window holder is connected to plate 146 via deformable hinges (e.g. torsion hinges) 154 and 156. Specifically, hinge 154 is fixed at both ends by anchors 158a and 158b; and hinge 156 is fixed at both ends by anchors 160a and 160b such that hinges 154 and 156 can be deformed. Hinge holder 162 is connected to pushing pin 164 with pin head 166 for maintaining the deformation directions of the hinges, and the rotation direction of projection lens 150. Pushing pin 164 is connected to transfer pin 168 that is connected to piezo electrical device 170. At the other end of the piezo electrical device, set screw 170 is displaced such that one end of the set screw abuts against the piezo electrical device; and the other end of the set screw abuts against a wall of plate 146. With this configuration, vibration of the piezo electrical device is transferred to holding plate 162, resulting in desired rotation of the transparent window.

The plate (146) can be made from any suitable materials, such as metals, plastic materials, and elastomers. The hinges may or may not be made from the same material as the plate. An exemplary material usable for the hinges can be Berylium-cupper. Piezo-electrical device can be a AE0505D18 piezo-electric stack from Thorlabs, and any other suitable piezo-electric devise, more preferably with the capability of providing 250 N or more forces.

In accordance with one example, the projection lens assembly as discussed above can be integrated to a housing wherein light valve and optical elements, such as condensing lenses and folding mirror if any, are enclosed. One of many such examples is demonstratively illustrated in FIG. 13. Referring to FIG. 13, within housing 178, light valve 180, folding mirror 182, field mirror 184, and projection lens assembly as discussed above are enclosed. Illumination system 176 is attached to the housing for providing light.

In operation, light from the illumination system enters into the housing and incident onto the folding mirror. The folding mirror reflects the light onto the field mirror 184, where the light is focused onto light valve 180. The modulated light from the light valve propagates towards the screen through the projection lens assembly. In this instance, the projection lens of the projection lens assembly is movable over time during the projection operation such that the reflected light from each pixel of the light valve can be projected onto different locations on the screen, as discussed earlier.

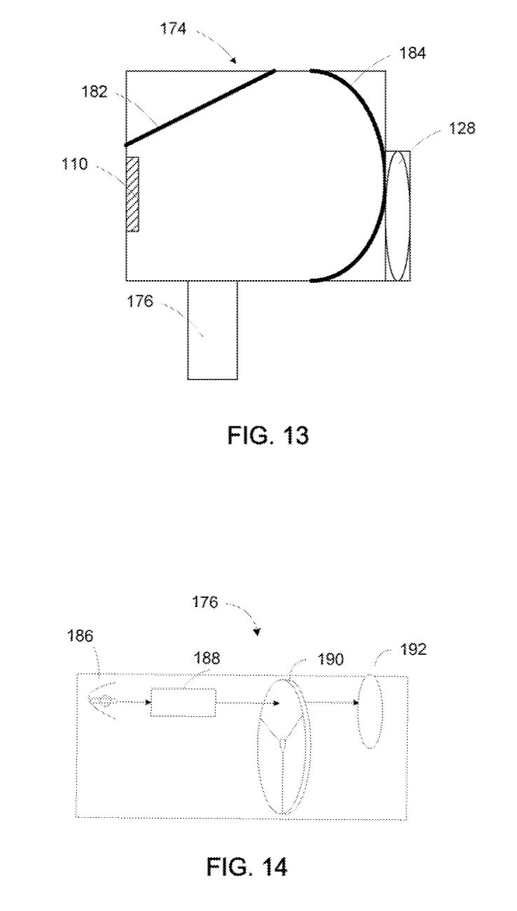

The light source (176) in the example can be any suitable light sources, one of which is illustrated in FIG. 14. Referring to FIG. 14, illumination system 176 comprises light source 186, light pipe 188, color wheel 190, and condensing lens 192. The light source can be an arc lamp with an elliptical reflector. The arc lamp may also be the arc lamps with retro-reflectors, such as Philips BAMI arc lamps. Alternatively, the arc lamp can be arc lamps using Wavien reflector systems each having a double parabola. The light source can also be a LED.

The color wheel comprises a set of color segments, such as red, green, and yellow, or cyan, yellow and magenta. A white or clear or other color segments can also be provided for the color wheel. In the operation, the color wheel spins such that the color segments sequentially pass through the illumination light from the light source and generates sequential colors to be illuminated on the light valve. For example, the color wheel can be rotated at a speed of at least 4 times the frame rate of the image data sent to the reflective light valves. The color wheel can also be rotated at a speed of 240 Hz or more, such as 300 Hz or more.

The lightpipe is provided for delivering the light from the light source to the color wheel and, also for adjusting the angular distributions of the illumination light from the light source as appropriate. As an alternative feature, an array of fly's eye lenses can be provided to alter the cross section of the light from the light source.

Condensing lens 192 may have a different f-number than the f-number of projection lens of the projection lens assembly (128) in FIG. 13. In this particular example, the color wheel is positioned after the light pipe along the propagation path of the light beams. In another embodiment, the color wheel can be positioned between the lightpipe and light source, which is not shown in the figure.

In the example as shown in FIG. 14, the color wheel is located behind of the light source and lightpipe at the propagation path of the illumination light. Alternatively, the color wheel can be displaced between the light source and lightpipe.

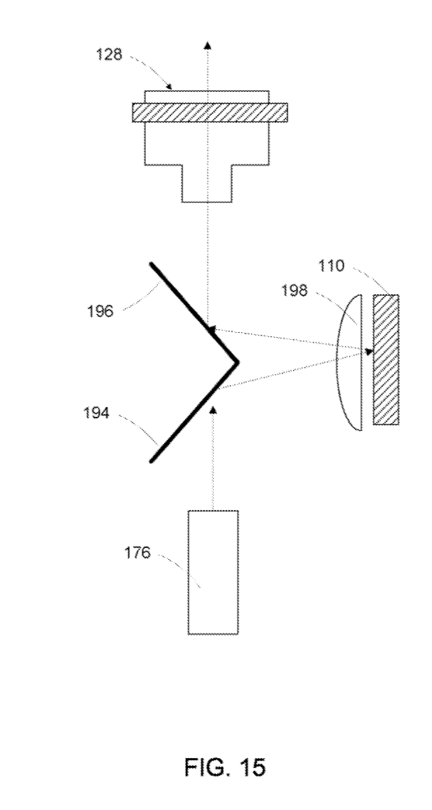

Another projection system is demonstratively illustrated in FIG. 15. Referring to FIG. 15, illumination system 176 provides illumination light for the system. The illumination light is incident to folding mirror 194 and reflected to light valve 110 through field lens 198. The light valve modulates the incident light based on image data derived from the desired image. The modulated light travels back to field lens 198 and impinges folding mirror 196, where the modulated light is guided to projection lens assembly 128. The projection lens assembly collects the modulated light and projects the modulated light onto screen for displaying. By moving the projection lens of the projection lens assembly during the projection operation, modulated light from each pixel of the light valve can be projected onto different locations on the screen.

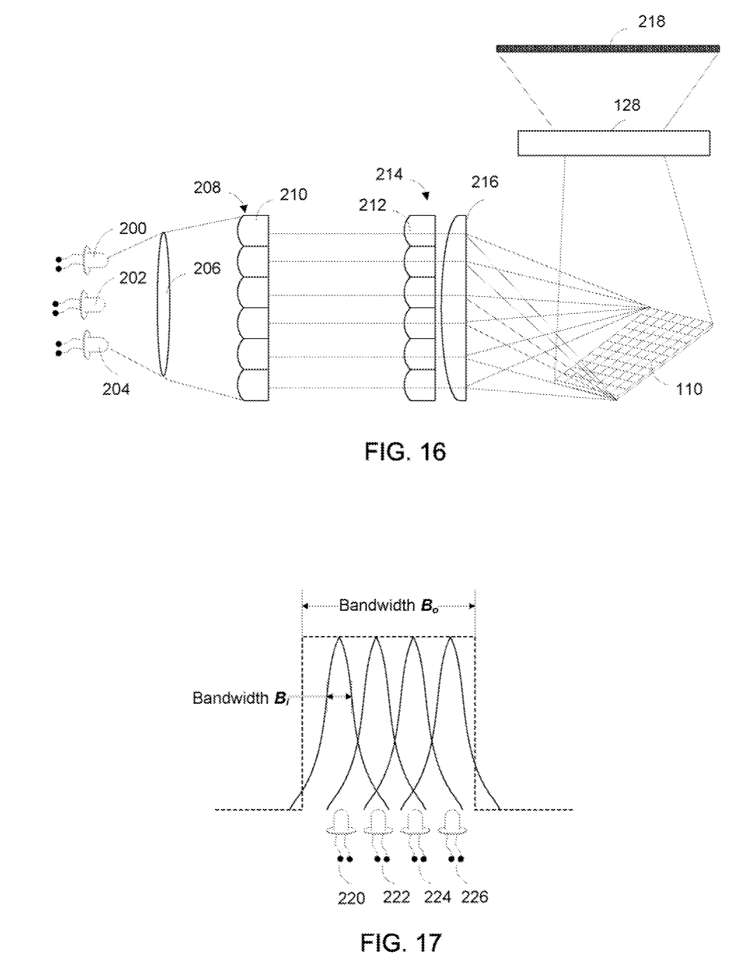

As discussed earlier, the projection system employing the projection lens assembly may use other suitable light sources for providing light; one of the examples is LED. An exemplary such projection system is demonstratively illustrated in FIG. 16. Referring to FIG. 16, the projection system comprises a LED array (e.g. LEDs 200, 202, and 204) for providing illumination light beam for the system. For demonstration purposes only, three LEDs are illustrated in the figure. In practice, the LED group may have any suitable number of LEDs, including a single LED. The LEDs can be of the same color (e.g. white color) or different colors (e.g. red, green, and blue). The light beams from the LED array are projected onto front fly-eye lens 208 through collimation lens 206. Fly-eye lens 208 comprises multiple unit lenses such as unit lens 210. The unit lenses on fly-eye lens 208 can be cubical lens or any other suitable lenses, and the total number of the unit lenses in the fly-eye lens 208 can be any desired numbers. At fly-eye lens 208, the light beam from each of the LEDs 200, 202, and 204 is split into a number of sub-light beams with the total number being equal to the total number of unit lenses of fly-eye lens 208. After collimate lens 206 and fly-eye lens 208, each LEDs 200, 202, and 204 is imaged onto each unit lens (e.g. unit lens 1212) of rear fly-eye lens 214. Rear fly-eye lens 214 comprises a plurality of unit lenses each of which corresponds to one of the unit lenses of the front fly-eye lens 208, such that each of the LEDs forms an image at each unit lens of the rear fly-eye lens 212. Projection lens assembly 128 projects the light beams from each unit lens of fly-eye lens 212 onto light valves 110. With the above optical configuration, the light beams from the LEDs (e.g. LEDs 200, 202, and 204) can be uniformly projected onto the micromirror devices of the light valves.

In the display system, a single LED can be used, in which instance, the LED preferably provides white color. Alternatively, an array of LEDs capable of emitting the same (e.g. white) or different colors (e.g. red, green, and blue) can be employed. Especially when multiple LEDs are employed for producing different colors, each color can be produced by one or more LEDs. In practical operation, it may be desired that different colors have approximately the same or specific characteristic spectrum widths. It may also be desired that different colors have the same illumination intensity. These requirements can be satisfied by juxtaposing certain number of LEDs with slightly different spectrums, as demonstratively shown in FIG. 17.

Referring to FIG. 17, it is assumed that the desired spectrum bandwidth of a specific color (e.g. red) is Bₒ (e.g. a value from 10 nm to 80 nm, or from 60 nm to 70 nm), and the characteristic spectrum bandwidth of each LED (e.g. LEDs 220, 222, 224, and 226) is Bᵢ (e.g. a value from 10 nm to 35 nm). By properly selecting the number of LEDs with suitable spectrum differences, the desired spectrum can be obtained. As a way of example, assuming that the red color with the wavelength of 660 nm and spectrum bandwidth of 60 nm is desired, the LEDs can be selected and juxtaposed as shown in the figure. The LEDs may have characteristic spectrum of 660 nm, 665 nm, 670 nm, and 675 nm, and the characteristic spectrum width of each LED is approximately 10 nm. As a result, the effective spectrum width of the juxtaposed LEDs can approximately be the desired red color with the desired spectrum width.

Different LEDs emitting different colors may exhibit different intensities, in which instance, the color balance is desired so as to generate different colors of the same intensity. An approach is to adjust the ratio of the total number of LEDs for the different colors to be balanced according to the ratio of the intensities of the different colors, such that the effective output intensities of different colors are approximately the same.

In the display system wherein LEDs are provided for illuminating a single light valve with different colors, the different colors can be sequentially directed to the reflective light valves. For this purpose, the LEDs for different colors can be sequentially turned on, and the LEDs for the same color are turned on concurrently. In another system, multiple light valves can be used as set froth in U.S. patent application “Multiple Reflective light valves in a Package” to Huibers, attorney docket number P266-pro, filed Aug. 30, 2005, the subject matter being incorporated herein by reference in entirety. A group of LEDs can be employed in such a display system for producing different colors that sequentially or concurrently illuminate the multiple reflective light valves.

The projection method and equivalences thereof can be implemented in display systems each having one light valve. Alternatively, the examples and equivalences can be implemented in display systems having multiple light valves. The multiple light valves may or may not be placed in the same package.

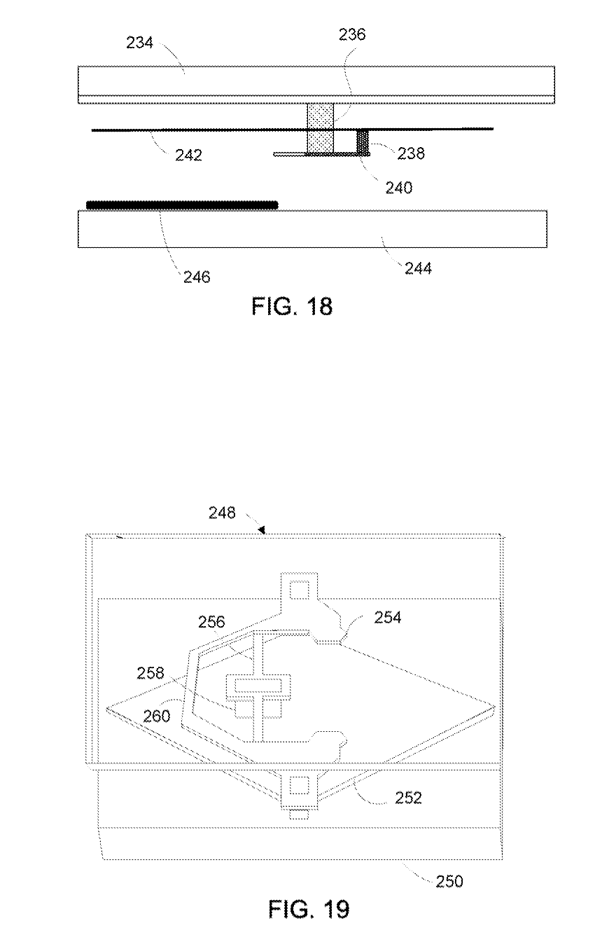

The light valves in the projection systems as discussed above each may be composed of any suitable elements, such as LCD elements, LCOS elements, micromirror devices, and other suitable elements. As a way of example, FIG. 18 illustrates a cross-section of an exemplary micromirror device. Referring to FIG. 18, the micromirror device comprises reflective deflectable mirror plate 242 that is attached to deformable hinge 240 via hinge contact 238. The deformable hinge, such as a torsion hinge is held by a hinge support that is affixed to post 236 on light transmissive substrate 234. Addressing electrode 246 is disposed on semiconductor substrate 244, and is placed proximate to the mirror plate for electrostatically deflecting the mirror plate. Other alternative features can also be provided. For example, a stopper can be provided for limiting the rotation of the mirror plate when the mirror plate is at the desired angles, such as the ON state angle. The ON state angle is preferably 100° degrees or more, 12° degrees or more, or 14° degrees or more relative to substrate 234. For enhancing the transmission of the incident light through the light transmissive substrate 234, an anti-reflection film can be coated on the lower surface of substrate 234. Alternative the anti-reflection film, a light transmissive electrode can be formed on the lower surface of substrate 234 for electrostatically deflecting the mirror plate towards substrate 234. An example of such electrode can be a thin film of indium-tin-oxide. The light transmissive electrode can also be a multi-layered structure. For example, it may comprise an electrically conductive layer and electrically non-conductive layer with the electrically conductive layer being sandwiched between substrate 234 and the electrically non-conductive layer. This configuration prevents potential electrical short between the mirror plate and the electrode. The electrically non-conductive layer can be SiOₓ, TiOₓ, SiNx, and NbOₓ, as set forth in U.S. patent application Ser. No. 11/102,531 filed Apr. 8, 2005, the subject matter being incorporated herein by reference. In other examples, multiple addressing electrodes can be provided for the micromirror device, as set forth in U.S. patent application Ser. No. 10/437,776 filed May 13, 2003, and Ser. No. 10/947,005 filed Sep. 21, 2004, the subject matter of each being incorporated herein by reference in entirety. Other optical films, such as a light transmissive and electrically insulating layer can be utilized in combination with the light transmissive electrode on the lower surface of substrate 234 for preventing possible electrical short between the mirror plate and light transmissive electrode.

In the example shown in FIG. 18, the mirror plate is associated with one single addressing electrode on substrate 244. Alternatively, another addressing electrode can be formed on substrate 244, but on the opposite side of the deformable hinge.

The micromirror device as show in FIG. 18 is only one of many applicable examples. For example, in the example as shown in the figure the mirror plate is attached to the deformable hinge such that the mirror plate rotates asymmetrically. That is the maximum rotation angle (e.g. the ON state angle) achievable by the mirror plate rotating in one direction (the direction towards the ON state) is larger than that (e.g. the OFF stat angle) in the opposite rotation direction (e.g. the direction towards the OFF state). This is accomplished by attaching the mirror plate to the deformable hinge at a location that is not at the center of the mirror plate such that the rotation axis of the mirror plate is offset from a diagonal of the mirror plate. However, the rotation axis may or may not be parallel to the diagonal. Of course, the mirror plate can be attached to the deformable hinge such that the mirror plate rotates symmetrically. That is the maximum angle achievable by rotating the mirror plate is substantially the same as that in the opposite rotation direction.

The mirror plate of the micromirror shown in FIG. 18 can be attached to the deformable hinge such that the mirror plate and deformable hinge are in the same plane. In an alternative example, the deformable hinge can be located in a separate plane as the mirror plate when viewed from the top of the mirror plate at a non-deflected state, which will not be discussed in detail herein.

Referring to FIG. 19, a perspective view of an exemplary micromirror device is illustrated therein. Deflectable reflective mirror plate 252 with a substantially square shape is formed on light transmissive substrate 248, and is attached to deformable hinge 256 via hinge contact 258. The deformable hinge is held by hinge support 260, and the hinge support is affixed and held by posts on the light transmissive substrate. For electrostatically deflecting the mirror plate, an addressing electrode (not shown in the figure for simplicity purposes) is fabricated in the semiconductor substrate 250. For improving the electrical coupling of the deflectable mirror plate to the electrostatic field, an extending metallic plate can be formed on the mirror plate and contacted to the mirror plate.

The mirror plate is preferably attached to the deformable hinge asymmetrically such that the mirror plate can be rotated asymmetrically for achieving high contrast ratio. The deformable hinge is preferably formed beneath the deflectable mirror plate in the direction of the incident light so as to avoid unexpected light scattering by the deformable hinge. For reducing unexpected light scattering of the mirror plate edge, the illumination light is preferably incident onto the mirror plate along a corner of the mirror plate.

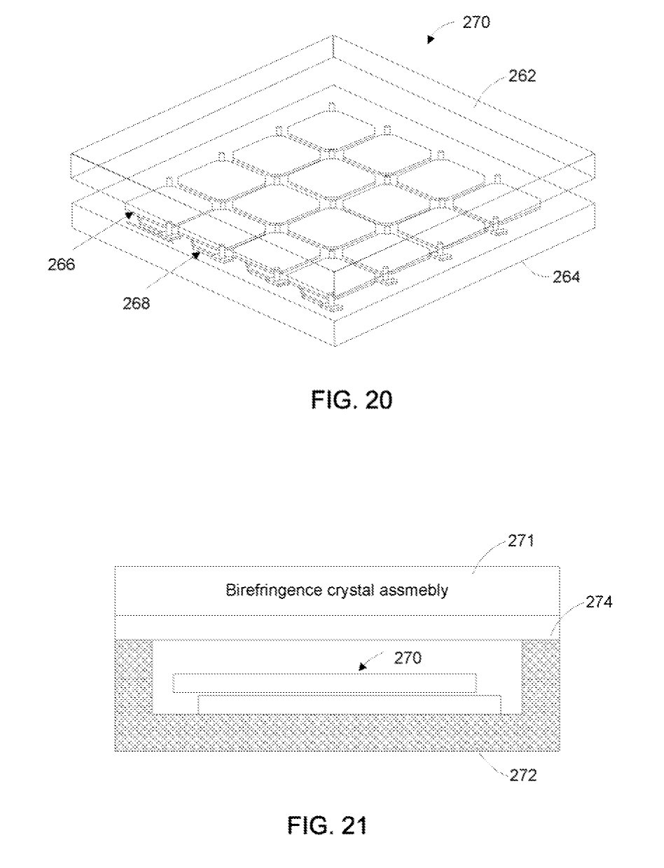

Referring to FIG. 20, an exemplary reflective light valve having an array of micromirrors of FIG. 19 is illustrated therein. For simplicity purposes, only 4×4 micromirrors are presented. In general, the micromirror array of reflective light valves consists of thousands or millions of micromirrors, the total number of which determines the resolution of the displayed images. For example, the micromirror array of the reflective light valves may have 800×600 (SVGA) or higher, 1024×768 (XGA) or higher, 1280×1024 (SXGA) or higher, 1280×720 or higher, 1400×1050 or higher, 1600×1200 (UXGA) or higher, and 1920×1080 or higher, micromirror devices. In other applications, the micromirror array may have less number of micromirrors.

In this example, the array of deflectable reflective mirror plates 266 is disposed between light transmissive substrate 262 and semiconductor substrate 264 having formed thereon an array of addressing electrodes 268 each of which is associated with a mirror plate for electrostatically deflecting the mirror plate. The posts of the micromirrors can be covered by light blocking pads for reducing expected light scattering from the surfaces of the posts.

Often times, the light valves are enclosed within a package for protection. One exemplary package is shown in FIG. 21. Referring to FIG. 21, light valve 270, such as that shown in FIG. 20, is disposed on the supporting surface of a cavity of package substrate 272 that can be a ceramic or other suitable materials. Package lid 274, which can be a light transmissive plate, is hermetically or non-hermetically bonded to the package substrate so as to enclose light valve 270 within the space between the package lid and package substrate. As one example, optical guiding module 271, such as that set forth in U.S. patent application Ser. No. 11/300,184 filed Dec. 15, 2005, the subject matter being incorporated herein by reference in entirety, can be disposed on the package lid, as shown in the figure. Alternatively, the light guiding module can be disposed within the space between the package lid and package substrate.

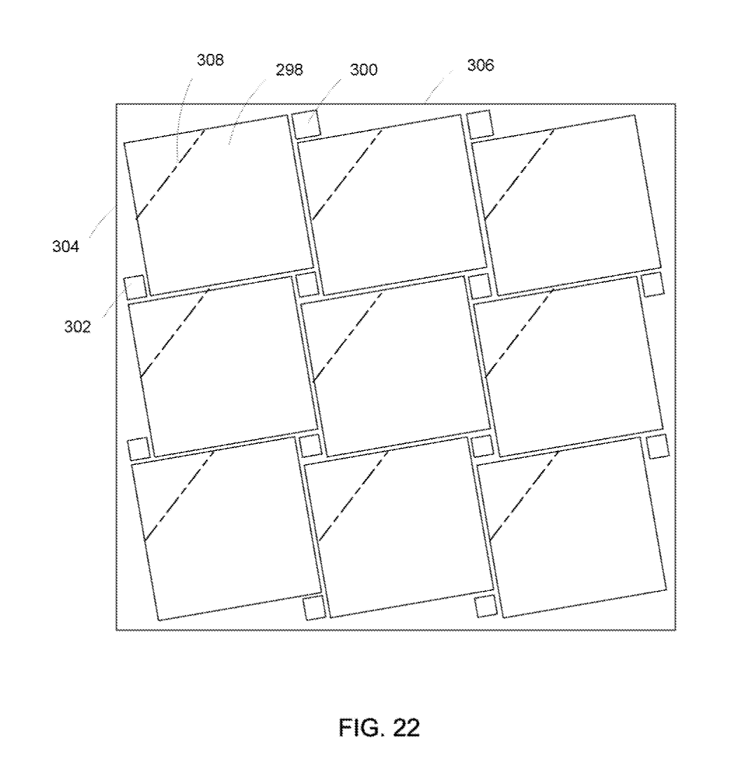

The micromirrors in the micromirror array of the reflective light valves can be arranged in alternative ways, another one of which is illustrated in FIG. 22. Referring to FIG. 22, each micromirror is rotated around its geometric center an angle less than 450° degrees. The posts (e.g. 300 and 302) of each micromirror (e.g. mirror 298) are then aligned to the opposite edges of the mirror plate. No edges of the mirror plate are parallel to an edge (e.g. edges 304 or 306) of the micromirror array. The rotation axis (e.g. axis 308) of each mirror plate is parallel to but offset from a diagonal of the mirror plate when viewed from the top of the mirror plate at a non-deflected state.

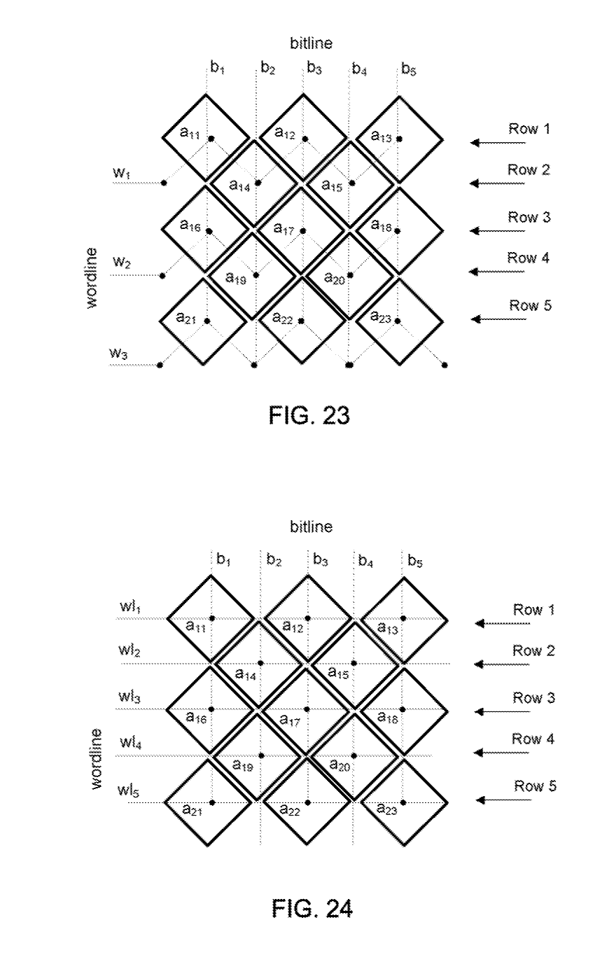

FIG. 23 illustrates the top view of another micromirror array having an array of micromirrors of FIG. 19. In this example, each micromirror is rotated 45° degrees around its geometric center. For addressing the micromirrors, the bitlines and wordlines are deployed in a way such that each column of the array is connected to a bitline but each wordline alternatively connects micromirrors of adjacent rows. For example, bitlines b₁, b₂, b₃, b₄, and b₅ respectively connect micromirrors groups of (a₁₁, a₁₆, and a₂₁), (a₁₄ and a₁₉), (a₁₂, a₁₇, and a₂₂), (a₁₅ and a₂₀), and (a₁₃, a₁₈, and a₂₃). Wordlines w₁, w₂, and w₃ respectively connect micromirror groups (a₁₁, a₁₄, a₁₂, a₁₅, and a₁₃), (a₁₆, a₁₉, a₁₇, a₂₀, and a₁₈), and (a₂₁, a₂₂, and a₂₃). With this configuration, the total number of wordlines is less the total number of bitlines.

For the same micromirror array, the bitlines and wordlines can be deployed in other ways, such as that shown in FIG. 24. Referring to FIG. 24, each row of micromirrors is provided with one wordline and one bitline. Specifically, bitlines b₁, b₂, b₃, b₄ and b₅ respectively connect column 1 (comprising micromirrors a₁₁, a₁₆, and a₂₁), column 2 (comprising micromirrors a₁₄ and a₁₉), column 3 (comprising micromirrors a₁₂, a₁₇, and a₂₂), column 4 (comprising micromirrors a₁₅ and a₂₀), and column 5 (comprising micromirrors a₁₃, a₁₈, and a₂₃). Wordlines WL₁, WL₂, WL₃, WL₄, and WL₅ respectively connect row 1 (comprising micromirrors a₁₁, a₁₂, and a₁₃), row 2 (comprising micromirrors a₁₄ and a₁₅), row 3 (comprising micromirrors a₁₆, a₁₇, and a₁₈), row 4 (comprising micromirrors a₁₉ and a₂₀) and row 5 (comprising micromirrors a₂₁, a₂₂, and a₂₃).

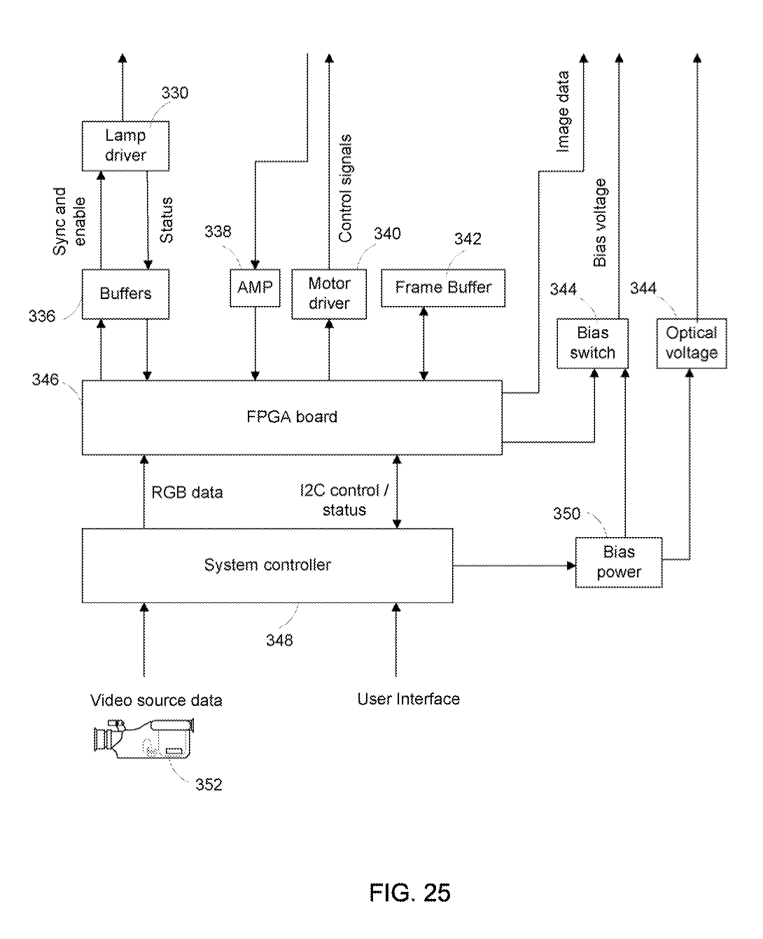

The image projection method as discussed above can be implemented in the system controller 106 as shown in FIG. 1. As a way of example, FIG. 25 illustrates a block diagram showing the functional modules of the projection system. The system comprises system controller 348 for receiving image or video contents from source 352, and providing the user interface. The system controller can be a computing device having a CPU or microcontroller, which is responsible for all system supervisory functions. Such functions include, but not limited to, initialization and shutdown of the projector system, monitoring of the system's real-time status (temperature, lamp state), the product's user interface, and video source selection. The system controller will often reside in a scalar IC such as a PixelWorks or similar chip. The system controller is expected to interface with FPGA board 346 over the standard I2C interface. The system controller may act as the I2C master and the FPGA board may act as an I2C slave. The system controller can initiate write transactions to set various parameters within the FPGA chip, or initiating read transactions to verify parameters or check various status indications within the FPGA board.

The FPGA board receives instructions and image data from the system controller. With such instruction, the FPGA board is capable of controlling lamp 102, color wheel 106, and spatial light modulator 110. Specifically, the FPGA board sends instructions (e.g. synchronization and enable signals) and driving signals to lamp driver through buffer 336. The lamp driver drives the lamp with the received instructions and driving signals. Operations status of the lamp can be real-timely monitored by retrieving the status of the lamp through the buffer to the FPGA. For driving the color wheel, the FPGA board real-timely monitors the status (e.g. the phase of the color wheel) using photodetector 334. The output signal from the photodetector is delivered to amplifier 338 where the signal is amplified. The amplified status signal is obtained by the FPGA and analyzed accordingly. Based on the analyzed status of the color wheel, the FPGA board sends instructions and driving signals (e.g. driving current) to motor driver that controls the color wheel. An exemplary method of controlling the operations of the color wheel is set forth in U.S. patent application Ser. No. 11/128,607 filed May 13, 2005, the subject matter being incorporated herein by reference.

The FPGA board may be connected to build-in buffer 342 for saving and retrieving data, such as image data (e.g. bitplane data complying with certain format, as set forth in U.S. patent applications Ser. No. 11/120,457 filed May 2, 2005, Ser. No. 10/982,259 filed Nov. 5, 2004, Ser. No. 10/865,993 filed Jun. 11, 2004, Ser. No. 10/607,687 filed Jun. 17, 2003, Ser. No. 10/648,608 filed Aug. 25, 2003, and Ser. No. 10/648,689 filed Aug. 25, 2005, the subject matter of each being incorporated herein by reference.

For controlling the operations of the micromirror devices in spatial light modulator 110, the FPGA communicates with the spatial light modulator and sends prepared image data retrieved from buffer 342 and instruction signals to the spatial light modulator. As an alternative feature, the bias on the micromirror devices of the light valve can be adjusted, e.g. by changing the amplitude and/or polarity for eliminating potential charge accumulation and other purposes, as set forth in U.S. patent applications Ser. No. 10/607,687 filed Jun. 17, 2003, Ser. No. 11/069,408 filed Feb. 28, 2005, and Ser. No. 11/069,317 filed Feb. 28, 2005, the subject matter of each being incorporated herein by reference.

The bias adjusting is accomplished through bias switch 344 and bias supply 350. The bias supply is connected to and controlled by system controller 348; while bias switch is controlled by the FPGA board.

For controlling the light guiding module (e.g. 114 in FIG. 1) so as to control the position of the projection lens assembly (and/or the light valve) of the projection system, optical voltage module 344 is provided. The control signals for driving the driving mechanism(s) (e.g. the piezo-electrical device(s)), and/or the electrostatic fields across the birefringent plates (if provided) can be supplied by bias-voltage module 350, even not required. Of course, a separate voltage source can be provided.

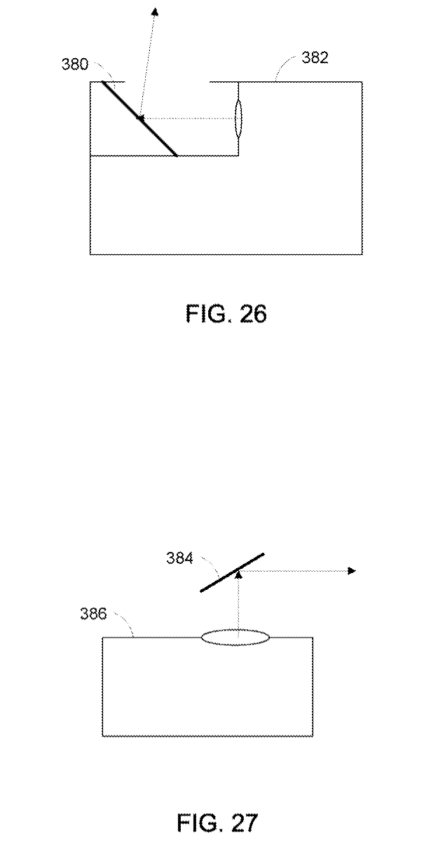

Alternative to moving the projection lens of the projection assembly, a moving folding mirror can be used for projecting the modulated light from the light valve onto different locations on the screen. In this instance, the projection lens, as well as the light valve may or may not be movable. The folding mirror can be placed at a location between the light valve and screen at the propagation path of the modulated light. Specifically, the movable folding mirror can be placed before, after, or even in the projection lens assembly. As a way of example, FIG. 26 demonstratively illustrates an exemplary projection system employing a movable folding mirror displaced after the projection lens assembly.

Referring to FIG. 26, movable folding mirror 380 is provided in the projection system 382. The projection system can be any suitable projection systems using light valves, such as those discussed above and other projection system with or without movable mechanisms for projecting modulated light from each pixel of the light valve onto different locations on the screen. The movable folding mirror is placed such that the modulated light from the projection lens assembly is folded onto the screen for viewing. During the operation when desired, the folding mirror is capable of moving relative to the screen such that the light from each pixel of the light valve can be projected onto different locations on the screen. The movement of the folding mirror can be accomplished through a piezo-electrical device attached to the folding mirror, or any other suitable mechanisms, such as micro-actuators.

FIG. 27 illustrates an alternative configuration of the system in FIG. 26. The folding mirror can be placed outside the projector enclosure. In particular, the folding mirror can be provided as a separate device from the projection system. The same as the folding mirror in FIG. 26, folding mirror 386 is movable for folding the projected light from the projection lens assembly in enclosure 384 onto different locations on the screen.

It will be appreciated by those skilled in the art that a new and useful projection methods and apparatus associated therewith have been described herein. In view of the many possible embodiments, however, it should be recognized that the embodiments described herein with respect to the drawing figures are meant to be illustrative only and should not be taken as limiting the scope of what is claimed. Those of skill in the art will recognize that the illustrated embodiments can be modified in arrangement and detail. Therefore, the devices and methods as described herein contemplate all such embodiments as may come within the scope of the following claims and equivalents thereof.

1. A method for shifting an image on a target, comprising:
directing light from a light source onto a light valve comprising an array of pixels;
modulating the light from the light source with the light valve pixels;
forming the image with the modulated light from the light valve on the target with a projection lens;
moving the projection lens so as to shift the formed image on the target.

2. The method of claim 1, wherein the projection lens is moved with a piezoelectric actuator.

3. (canceled)

4. The method of claim 3, wherein a housing encasing the plurality of projection lenses is moved.

5. (canceled)

6. The method of claim 4, further comprising a hinge disposed to allow the movement of the housing.

7. The method of claim 6, wherein a first hinge is provided on a first side of the housing and a second hinge is provided on a second side of the housing.

8. (canceled)

9. The method of claim 1, wherein the projection lens is translationally moved.

10-11. (canceled)

12. The method of claim 1, wherein the light valve is a micromirror array.

13-18. (canceled)

19. The method of claim 1, wherein the image is shifted from first position to second position due to the movement of the projection lens.

20. The method of claim 19, wherein a frame of image data is provided to form a first sub frame of image data and a second sub frame of image data, wherein the first sub frame of image data is provided to the light valve when pixel images are in the first positions on the target and wherein the second sub frame of image data is provided to the light valve when the pixel images are in the second positions on the target.

21. The method of claim 1, wherein a color wheel is provided to direct a series of colored light beams onto the light valve.

22-25. (canceled)

26. The method of claim 19, wherein the positions are substantially linear in spatial arrangement on the target.

27-39. (canceled)

40. The method of claim 1, wherein the movement of the projection lens is through a total distance of from 1 to 50 microns.

41-43. (canceled)

44. A projection system, comprising:
a light source for providing light to a light valve;
a light valve with a plurality of light valve elements for spatially modulating light from the light source;
a projection lens through which light from the light valve passes; and
a piezoelectric actuator provided for moving the projection lens.

45-90. (canceled)

91. A projection system, comprising:
a light source for providing light onto a light valve;
a light valve having individual light valve elements which reflect or transmit light to a screen;
means for vibrating the light valve so as to shift the pixel images from the light valve elements on the screen.

92. The system of claim 91, wherein the means for vibrating the light valve comprises a piezoelectric mechanism connected directly or indirectly to the light valve so as to shift the pixel images from the light valve elements on the screen.

93. The projection system of claim 92, wherein the light valve is connected via one or more flexure hinges to the piezoelectric mechanism.

94-96. (canceled)

97. The method of claim 92, wherein the movement of the projection lens is in a form of vibration; and wherein the vibration has a characteristic frequency of 60 HZ or higher.

98. The method of claim 92, wherein the movement of the projection lens is in a form of vibration; and wherein the vibration has a characteristic frequency of 120 HZ or higher.

99-119. (canceled)

120. The method of claim 92, wherein the light valve is a spatial light modulator that is connected to a flex package.

121-143. (canceled)

144. The system of claim 91, wherein the light valve is a micromirror array.
